(19) United States
(12) Patent Application Publication
(10) Pub. No.: US 2018/0178501 A1
(43) Pub. Date: Jun. 28, 2018

(54) Surface Coated Structural Members Suitable for Marine Environments and Method of Production

(71) Applicant: Kent Weisenberg, Jacksonville, FL (US)

(72) Inventor: Kent Weisenberg, Jacksonville, FL (US)

(21) Appl. No.: 15/581,771

(22) Filed: Apr. 28, 2017

Related U.S. Application Data
(60) Provisional application No. 62/437,858, filed on Dec. 22, 2016.

(51) Int. Cl. B32B 37/24; B32B 38/00

(52) U.S. Cl. CPC B32B 37/24; B32B 2038/0084; B32B 2037/243; B32B 38/00

(57) ABSTRACT

A method of producing a combination structural member and surface coating or covering, and the product so produced. The surface covering is composed of at least two layers—an outer layer of vibration oriented polymer granules adhesively bonded together at a density that allows the layer to be highly porous to liquid and such that it presents a non-planar upper surface for enhanced traction, and a bonding/sealing inner layer formed of an aliphatic urethane bonding agent—the bonding/sealing agent producing a liquid impermeable barrier on the structural member. The bonding/sealing layer is applied as an uncured inner layer on the structural member and the polymer granules are then applied onto the bonding/sealing layer.

### BACKGROUND OF THE INVENTION

This invention relates generally to surface coated structural members, such as boards or sheets utilized in floors, walkways, posts, railings, docks, etc., and in particular such coated structural members that are exposed to the environment, and even more particularly to such coated structural members that are used in outdoor marine environments. The invention also relates to methods of producing such products.

Many surfaces and structural members, composed for example of wood, plastic or composite materials, are exposed to the environment and thereby subjected to environmental degradation, soiling, the growth of mold or mildew, dangerous loss of traction, etc. Wooden or composite material docks extending over bodies of water and exposed to the elements are examples of structural members particularly susceptible to environmental degradation.

Most waterfront homes and waterfront commercial venues have docks, piers or decks exposed to the environment. If made from wood, the wood is treated to increase resistance to the environmental degradation, typically by applying a waterproofing compound. It is also common to construct the docks, piers and decks from manufactured composite materials, often comprising cellular PVBC or wood composites encapsulated in polyethylene. When these materials degrade, they are typically repaired by removing the damaged material and replacing the material with new pieces.

Typical structural material used in docks, piers and decks is slippery when wet, degrades to form splinters or cracks, becomes uncomfortably hot from the sun, warps to expose nails or screws, presents uneven and rough surfaces, and is susceptible to mold, mildew, stains, bug infestation, etc. Painting the surfaces, providing adhesive-backed non-slip tapes, etc. are not satisfactory solutions to the problems.

It is an object of this invention to provide a surface coated structural member and a method of producing such a product that addresses the problem of environmental exposure and degradation by providing a surface covering on the structural members, the surface covering, among other benefits, providing a barrier against environmental exposure and degradation that is suitable for use in construction, retrofitting, repair and resurfacing, and is particularly effective in marine environments.

### SUMMARY OF THE INVENTION

The invention is the combination of a structural member and a surface coating or covering, and the method of producing such product. The structural member may be made of wood, plastic, composite material, metal or the like, and may be produced as boards, posts, rails, sheets, panels, etc. The surface covering is composed of at least two layers—an outer surface layer of vibration oriented and settled polymer granules adhesively bonded together at a density that allows the layer to be porous to liquid, and further such that it presents a non-planar upper surface for enhanced traction, and a bonding/sealing inner layer formed of an aliphatic urethane bonding agent or similar adhesive composition—the bonding/sealing agent producing a liquid impermeable barrier on the structural member upon full curing.

A structural member is placed onto a horizontal vibration bed within lateral form members and coated with the curable bonding/sealing agent as an inner layer, which upon curing forms a liquid impermeable barrier layer that seals the structural member. The outer layer is formed by mixing polymer granules and a polymeric adhesive to create a curable granular mixture, which is then placed onto the area of the structural member containing the sealing/bonding agent prior to complete curing of the sealing/bonding agent. The granular mixture is then tamped and vibrated to orient and settle the polymer granules, such that upon the curing of both layers the surface covering is the proper thickness and density, is firmly adhered to the structural member by the inner layer, and possesses irregular channels and voids in the outer layer for the rapid drainage of liquid to preclude or minimize pooling of liquid on the surface.

The structural member may be coated on one side, all four sides, all four sides with ends, sides only, bottom or top only, one side only, etc., as desired. The bonding/sealing agent and the polymer granule mixture may be applied in stages to different sides of the structural member depending on how many and which sides are to be coated.

The surface coated structural member so produced can be cut to any desired shape, and can be combined with other structural members by mechanical fasteners, adhesives, etc., to form a desired structure.

In alternative format, the invention in various embodiments is a method of coating a structural member comprising the steps of preparing a curable mixture of polymer granules and a bonding agent; applying a curable bonding/sealing agent to a structural member as an inner layer; placing said mixture on said bonding/sealing agent as an outer layer prior to complete curing of said bonding/sealing agent and prior to curing of said mixture; tamping and vibrating said mixture to achieve a desired thickness and density, said density being chosen such that said mixture when cured comprises irregular channels and voids; and allowing said mixture and said bonding/sealing agent to cure, whereby said inner layer is liquid impermeable and said outer layer is porous. Furthermore the method above, wherein said bonding/sealing agent is applied to more than one surface of said structural member, further comprising the step of choosing said polymer granules from the group of polymer granules consisting of thermoplastic vulcanizate (TPV), ethylene propylene diene monomer (EPDM), polyolefin material, or mixtures thereof; wherein said polymer granules are approximately 1 to 5 mm in size and irregularly shaped; and/or wherein said step of placing said mixture on said bonding/sealing agent comprises placing a first portion of said mixture on a first portion of said bonding/sealing agent; said step of tamping and vibrating said mixture comprises tamping and vibrating said first portion of said mixture; and wherein prior to said step of allowing said mixture and said bonding/sealing agent to cure, said method further comprises the steps of placing a second portion of said mixture on a second portion of said bonding/sealing agent as an outer layer prior to complete curing of said bonding/sealing agent; tamping and vibrating said second portion mixture on said second portion of said bonding/sealing agent to achieve a desired thickness and density, said density being chosen such that said mixture when cured comprises irregular channels and voids.

Alternatively, a method of coating a multi-sided structural member comprising the steps of preparing a curable mixture of polymer granules and a bonding agent suitable for bonding said polymer granules; applying a curable bonding/sealing agent to more than one side of said structural member as an inner layer, said bonding/sealing agent suitable for bonding said polymer granules to said structural member, said bonding/structural layer forming a liquid impermeable layer on said structural member upon curing; placing said structural member on a vibration bed within form members, there being one or more gaps defined between said structural member and said form members; placing an uncured first portion of said mixture in said one or more gaps as an outer layer prior to complete curing of said bonding/sealing agent; tamping and vibrating said first portion of said mixture to achieve a desired thickness and density in said one or more gaps, said density being chosen such that said mixture when cured comprises irregular channels and voids rendering said cured mixture porous; placing an uncured second portion of said mixture on a remaining exposed side of said bonding/sealing agent as an outer layer prior to complete curing of said bonding/sealing agent; tamping and vibrating said second portion of said mixture to achieve a desired thickness and density, said density being chosen such that said mixture when cured comprises irregular channels and voids rendering said cured mixture porous; and allowing said mixture and said bonding/sealing agent to cure. Furthermore to the above, wherein said bonding/sealing agent is applied to two opposing sides and a top of said structural member, further comprising the step of choosing said polymer granules from the group of polymer granules consisting of thermoplastic vulcanizate (TPV), ethylene propylene diene monomer (EPDM), polyolefin material, or mixtures thereof, wherein said polymer granules are approximately 1 to 5 mm in size and irregularly shaped; and/or further comprising the steps of inverting said structural member on said vibration bed to expose an uncoated opposing side of said structural member, coating said opposing side with said curable bonding/sealing agent, placing an uncured third portion of said mixture on said bonding/sealing agent on said opposing side, tamping and vibrating said third portion of said mixture to achieve a desired thickness and density, said density being chosen such that said mixture when cured comprises irregular channels and voids rendering said cured mixture porous, allowing said third portion of said mixture and said bonding/sealing agent to cure.

Alternatively, a surface coated structural member formed by the process of preparing a curable mixture of polymer granules and a bonding agent suitable for bonding said polymer granules; applying a curable bonding/sealing agent to a structural member as an inner layer, said bonding/sealing agent suitable for bonding said polymer granules to said structural member and suitable for forming a liquid impermeable layer on said structural member upon curing; placing said mixture on said bonding/sealing agent as an outer layer prior to complete curing of said bonding/sealing agent; tamping and vibrating said mixture to achieve a desired thickness and density, said density being chosen such that said mixture when cured comprises irregular channels and voids rendering said cured mixture porous; allowing said mixture and said bonding/sealing agent to cure; such that said surface coated structural member comprises a liquid-impermeable inner layer and a porous outer layer. Furthermore, wherein said step of placing said mixture on said bonding/sealing agent comprises placing a first portion of said mixture on a first portion of said bonding/sealing agent, said step of tamping and vibrating said mixture comprises tamping and vibrating said first portion of said mixture, and wherein prior to said step of allowing said mixture and said bonding/sealing agent to cure, said method further comprises the steps of placing a second portion of said mixture on a second portion of said bonding/sealing agent as an outer layer prior to complete curing of said bonding/sealing agent, tamping and vibrating said second portion mixture on said second portion of said bonding/sealing agent to achieve a desired thickness and density, said density being chosen such that said mixture when cured comprises irregular channels and voids; and/or further comprising the steps of inverting said structural member to expose an uncoated opposing side of said structural member, coating said opposing side with said curable bonding/sealing agent, placing an uncured third portion of said mixture on said bonding/sealing agent on said opposing side, tamping and vibrating said third portion of said mixture to achieve a desired thickness and density, said density being chosen such that said mixture when cured comprises irregular channels and voids rendering said cured mixture porous, allowing said third portion of said mixture and said bonding/sealing agent to cure.

### BRIEF DESCRIPTION OF THE DRAWINGS

FIG. 1 is a cross-sectional view of one embodiment for a coated structural member showing the outer layer and the bonding/sealing inner layer applied to the structural member on the top surface.

FIG. 2 is a cross-sectional view of one embodiment for a coated structural member showing the outer layer and the bonding/sealing inner layer encasing the structural member on the top and side surfaces.

FIG. 3 is a cross-sectional view of a second embodiment for a coated structural member showing the outer layer and the bonding/sealing inner layer encasing the structural member on the bottom, top and side surfaces.

FIG. 4 is a cross-sectional view showing a sheet or panel structural member positioned atop a vibration bed, the bonding/sealing layer having been applied to the top and lateral surfaces of the structural member, and a lateral gap present to receive the polymer granules.

FIG. 5 is a flow chart illustrating the general methodology of forming a coated structural member.

FIG. 6 is a flow chart illustrating the methodology of producing a coated structural member of the type illustrated in FIG. 2.

FIG. 7 is a flow chart illustrating the methodology of producing a coated structural member of the type illustrated in FIG. 3.

### DETAILED DESCRIPTION OF THE INVENTION

The invention is the combination of a structural member 10, such as a board, post, rail, sheet, panel, etc. formed of wood, plastic, metal, composite material or the like, and a surface coating or covering, and the method of producing such a product. The surface covering is composed of at least two layers—a traction and drainage outer layer 12 of vibration oriented and settled polymer granules adhesively bonded together at a density that allows the layer to be significantly porous to liquid and such that it presents a non-planar upper surface on a small dimensional scale for enhanced traction, and a bonding/sealing inner layer 11 formed of suitable adhesive or bonding material, such as for example an aliphatic urethane bonding or adhesive agent—the bonding/sealing agent being both a bonding agent and a sealing agent, so as to form a liquid impermeable sealing barrier on the structural member 10 when cured as well as securely bonding the outer layer 12 to the structural member 10.

The outer layer 12 is formed by mixing polymer granules or particles and a suitable polymeric adhesive or bonding agent, such as an aliphatic urethane resin for example, to create a curable granular mixture or sludge. The granules may be composed for example of granulated thermoplastic vulcanizate (TPV), ethylene propylene diene monomer (EPDM), polyolefin material, or mixtures thereof. The particles or granules are preferably between approximately 1 to 5 millimeters in size and are preferably irregularly shaped.

The structural member 10 forming the structural core of the product is properly cleaned or otherwise processed for ready acceptance of the inner layer 11. For example, if the structural member 10 is composed of pressure treated lumber, the lumbar should be air- or kiln-dried to ensure that all volatiles have been dispersed. The structural member 10 is then coated with the bonding/sealing agent on one or more sides or ends, preferably at a thickness of approximately 40-60 mils, and placed onto a horizontal vibration bed 20.

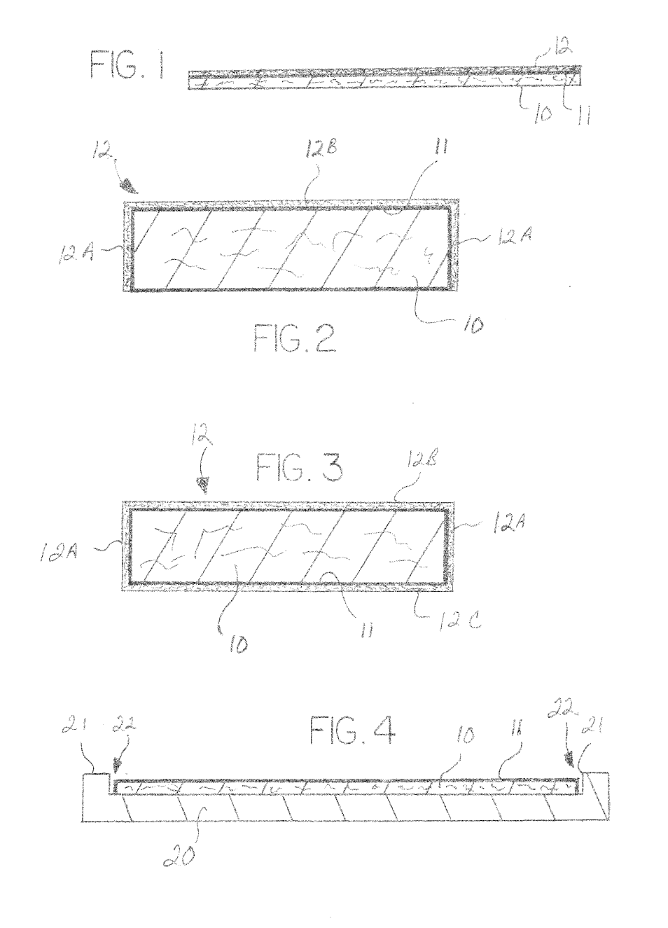

To create a structural member 10 surface coated on a single side, as shown in FIG. 1, the curable bonding/sealing agent is applied to the exposed surface of the structural member 10 and the granule mixture is then positioned atop the bonding/sealing agent prior to curing of the bonding/sealing agent and the granule mixture. The granule mixture is then tamped and vibrated into the desired thickness and porosity/density. The bonding/sealing agent cures to form a liquid impermeable inner layer 11 and the granule mixture cures to form the high drainage and high traction outer layer 12. Alternatively, the coated structural member 10 of FIG. 1 may be created by placing a layer of the granular mixture onto the horizontal vibration bed 20 prior to placement of a structural member 10 already coated with the bonding/sealing agent, with pressure then applied to the structural member 10 as needed to properly tamp the granules forming outer layer 12, followed by vibration to orient and settle the granules, then ultimate curing. It is also possible to modify this process to simultaneously coat multiple structural members 10, such as for example a plurality of 2×4 wooden boards, by laying the structural members 10 side-by-side on the vibration bed 20 and then applying the bonding/sealing agent and granule mixture across all the structural members 10 at once.

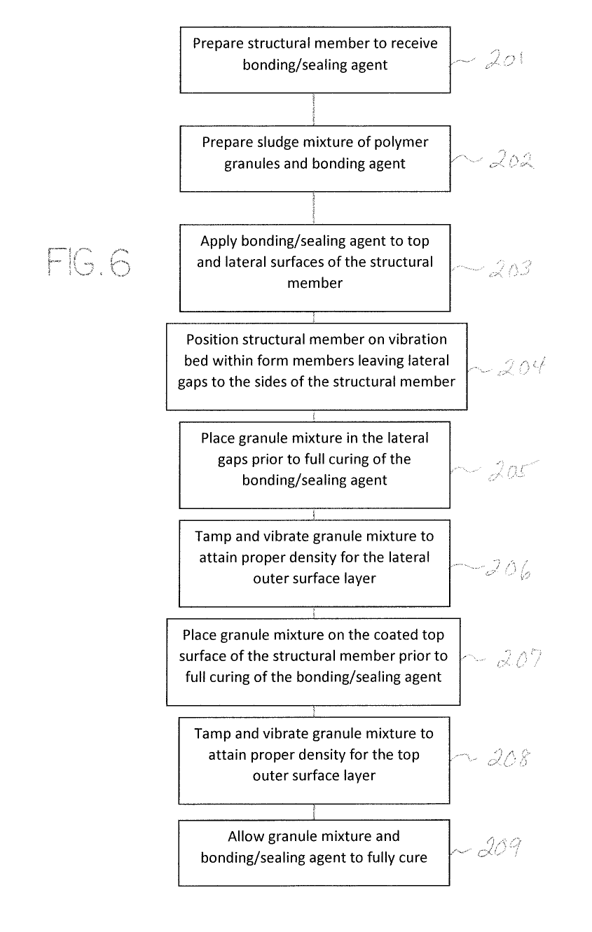

To create a structural member 10 surface coated on the top and sides, the structural member 10 is coated with the bonding/sealing agent on the top and sides and placed onto the vibration bed 20 between lateral form members 21, there being small gaps 22 present on each side of the structural member 10, as shown in FIG. 4. A first portion of the granular mixture is then positioned on a first portion of the bonding/sealing agent within the gaps 22 between the sides of the structural member 10 and lateral form members 21, the gaps 22 being preferably about one eighth to three eighths inches in thickness. Initially only the sides of the structural member 10 are coated with the granular mixture, or the sides and ends of the structural member 10 if desired, while the top surface of the structural member 10 remains uncovered. The granular mixture is applied while the bonding/sealing agent, which ultimately cures to form the liquid impermeable inner layer 11, is not yet fully cured. The granular mixture is then tamped and vibrated to properly orient and settle the particles to produce a lateral outer layer 12A on the sides of the structural member 10 of the desired thickness and density. Vibration may occur, for example, at a rate of up to 100,000 vibrations per minute with vibration at of up to 5000 force pounds. The second or remaining portion of the bonding/sealing mixture on the exposed top side of the structural member 10 is then covered with a second portion of the granular mixture, also prior to complete curing of the bonding/sealing agent, and tamped and vibrated to produce a top surface outer layer 12B integrally bonded with the lateral surface outer layer 12A. Upon full curing of the bonding/sealing agent, the outer layer 12 is fully adhered to the liquid impermeable inner layer 11, which in turn is adhered to the surfaces of the structural member 10.

In another alternative embodiment, a layer of the granular mixture is placed onto the horizontal vibration bed 20 prior to placement of a structural member 10 already coated with the bonding/sealing agent, with pressure then applied to the structural member 10 as needed to properly tamp the bottom outer layer 12C, followed by vibration to orient and settle the granules. The lateral outer layers 12A and top outer layer 12B are then produced as described above. This process results in a structural member 10 coated on its top, bottom and side surfaces, such that the core is fully encased in the surface or outer coating 12, as shown in FIG. 3. Alternatively still, the bottom outer layer 12C may be produced by inverting a structural member 10 previously coated laterally and on the top such that the uncoated bottom of the structural member 10 is exposed. The bonding/sealing agent is then applied to the exposed bottom surface and the granules are applied to form the outer layer 12C in similar manner as the top outer layer 12B was initially formed. In similar manner by choosing the proper methodology steps, a structural member 10 may be coated on all four sides along with its ends, on sides only, bottom or top only, one side only, top and bottom only, top and one side, etc.

This methodology results in a structural member 10 having a core and an outer surface layer 12 securely bonded thereto, the surface layer 12 having an extensive randomly disposed channel network such that water and other liquids can move laterally through the outer layer 12 to quickly drain from the outer layer 12. The structural member 10 is protected from environmental degradation by the combination of the liquid impermeable inner layer 11 and the outer coating layer 12. The surface coated structural member 10 so produced can be cut to any desired shape, and nailed or screwed as needed. The density of the outer surface layer 12 allows the screw or nail head to be advanced a sufficient distance so as to be recessed within the outer layer 12.

As a representative example, the polymer granules may comprise granulated thermoplastic vulcanizate (TPV) having a density of approximately 1.59 kg/dm³+/−0.04. The granules have a loose bulk density (i.e., no bonding agent and not tamped or vibrated) of approximately 660 gr/l, and a compressed or final bulk density (i.e., mixed with bonding agent, tamped, vibrated and cured) of approximately 740 gr/l. This cured surface coating will have a tensile strength of approximately 6.0 N/mm², an elongation at break of approximately 650%, and a Shore A hardness value of 62+/−5.

Because the polymer granules of the outer layer 12 do not form a surface having a continuously planar upper surface when examined on micro-scale, there being gaps and channels present between adjacent granules, the upper layer 12 possesses good non-slip properties. The high traction surface covering as described possesses a wet dynamic coefficient of friction (DCOF) in excess of approximately 0.94, which greatly exceeds the American Disabilities Act and Occupational Safety and Health standards. The surface covering is significantly cooler than comparative materials, has greater impact attenuation, good anti-static properties, high UV resistance, high resistance to mold, mildew, fungus and insect propagation, high chemical resistance, high resistance to weathering, wet/dry cycling, chipping, cracking and splintering. Characterization testing shows the surface covering to be 5 times more slip resistant than composite decking (static and dynamic/wet and dry), three times more slip resistant than treated bare wood decking (static and dynamic/wet and dry) and three times greater in fall attenuation than bare wood or composite decking. The surface of the outer layer 12 stays 24% cooler than composite decking in direct sunlight, 20% cooler than bare wood decking and 32% cooler than painted wood decking. Additional benefits and improved characteristics of the invention include that the product is greater than 25% stronger than standard treated boards and greater than twice the breaking strength of composite boards.

The outer surface covering 12 may be provided with additional surface coatings to improve the characteristics listed above, such as by applying a super-hydrophobic, hydrophobic or oleo-phobic coating to prevent staining or improve water channeling.

With reference to FIGS. 5 through 7, various embodiments of the methodology are set forth. FIG. 5 illustrates a broad methodology comprising the steps of preparing 101 the structural member to receive the bonding/sealing agent, preparing 102 the sludge mixture of polymer granules and bonding agent, applying 103 the bonding/sealing agent to at least one surface of the structural member, positioning 104 the structural member on the vibration bed within form members, placing 105 the granule mixture adjacent the bonding/sealing agent prior to full curing of the bonding/sealing agent, tamping and vibrating 106 the granule mixture to attain property density, optionally repeating 107 steps 105 and 106 to additional structural member surfaces, and allowing 108 the granule mixture and bonding/sealing agent to fully cure to form the liquid impermeable inner layer and the fast draining, high traction outer layer. Absent, the option repeating step 107, this methodology may be used to form a coated structural member as shown in FIG. 1.

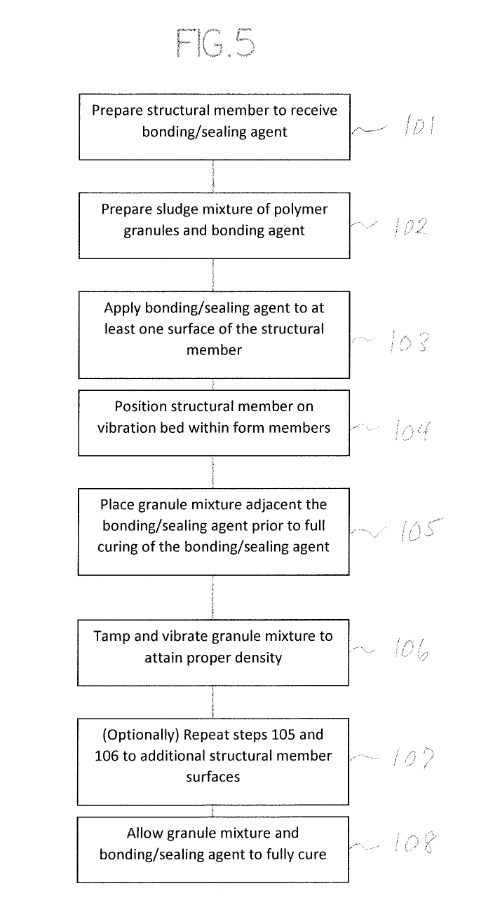

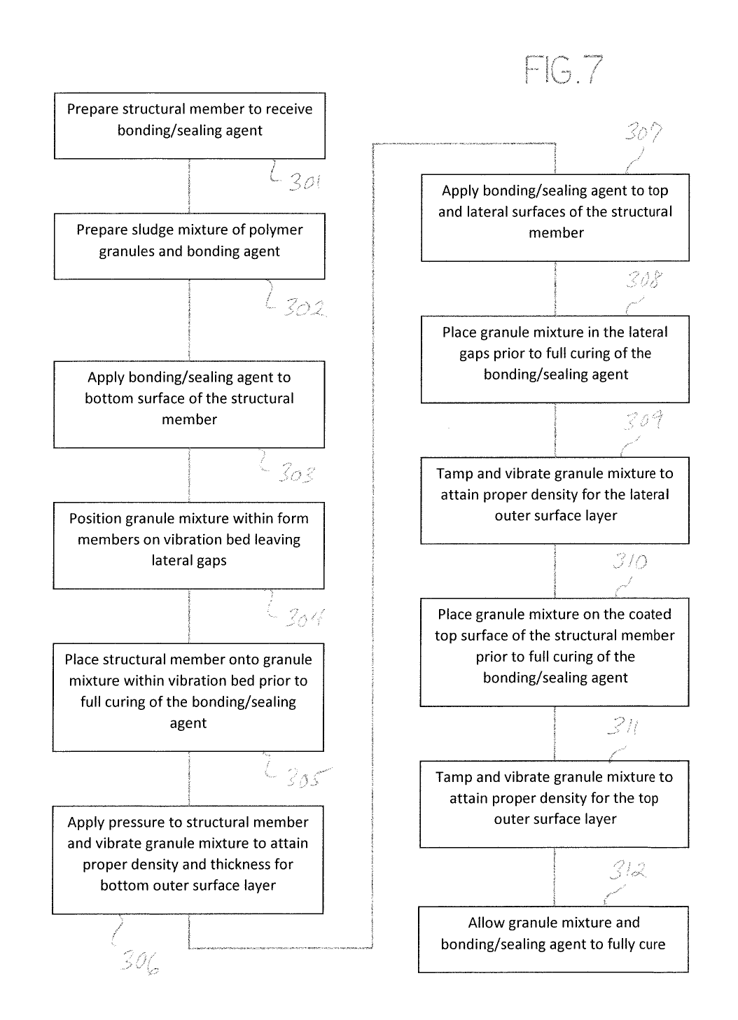

FIG. 6 illustrates the methodology suitable to produce a structural member of the type illustrated in FIG. 2, the method comprising the steps of preparing 201 the structural member to receive the bonding/sealing agent, preparing 202 the sludge mixture of polymer granules and bonding agent, applying 203 the bonding/sealing agent to the top and lateral surfaces of the structural member, positioning 204 the structural member on the vibration bed within form members leaving lateral gaps on the sides of the structural member, placing 205 the granule mixture in the lateral gaps prior to full curing of the bonding/sealing agent, tamping and vibrating 206 the granule mixture to attain property density for the lateral outer surface layer, placing 207 the granule mixture on the coated top surface of the structural member prior to full curing of the bonding/sealing agent, tamping and vibrating 208 the granule mixture to attain proper density and thickness for the top outer surface layer, and allowing 209 the granule mixture and bonding/sealing agent to fully cure to form the liquid impermeable inner layer and the fast draining, high traction outer layer.

FIG. 7 illustrates the methodology suitable to produce a structural member of the type illustrated in FIG. 3, the method comprising the steps of preparing 301 the structural member to receive the bonding/sealing agent, preparing 302 the sludge mixture of polymer granules and bonding agent, applying 303 the bonding/sealing agent to the bottom surface of the structural member, positioning 304 the granule mixture within the form members on the vibration bed leaving lateral gaps, placing 305 the structural member onto the granule mixture within the vibration bed prior to full curing of the bonding/sealing agent, applying pressure to the structural member and vibrating 306 the granule mixture to attaining the proper density and thickness for the bottom outer surface layer, applying 307 the bonding/sealing agent to the top and lateral surfaces of the structural member, placing 308 the granule mixture in the lateral gaps prior to full curing of the bonding/sealing agent, tamping and vibrating 309 the granule mixture to attain property density for the lateral outer surface layer, placing 310 the granule mixture on the coated top surface of the structural member prior to full curing of the bonding/sealing agent, tamping and vibrating 311 the granule mixture to attain proper density and thickness for the top outer surface layer, and allowing 312 the granule mixture and bonding/sealing agent to fully cure to form the liquid impermeable inner layer and the fast draining, high traction outer layer.

It is understood that equivalents and substitutions for certain elements described above may be obvious to those of skill in the art, and therefore the true scope and definition of the invention is to be as set forth in the following claims.

I claim:

1. A method of coating a structural member comprising the steps of:
preparing a curable mixture of polymer granules and a bonding agent;
applying a curable bonding/sealing agent to a structural member as an inner layer;
placing said mixture on said bonding/sealing agent as an outer layer prior to complete curing of said bonding/sealing agent and prior to curing of said mixture;
tamping and vibrating said mixture to achieve a desired thickness and density, said density being chosen such that said mixture when cured comprises irregular channels and voids; and
allowing said mixture and said bonding/sealing agent to cure, whereby said inner layer is liquid impermeable and said outer layer is porous.

2. The method of claim 1, wherein said bonding/sealing agent is applied to more than one surface of said structural member.

3. The method of claim 1, further comprising the step of choosing said polymer granules from the group of polymer granules consisting of thermoplastic vulcanizate (TPV), ethylene propylene diene monomer (EPDM), polyolefin material, or mixtures thereof.

4. The method of claim 3, wherein said polymer granules are approximately 1 to 5 mm in size and irregularly shaped.

5. The method of claim 1, wherein:
said step of placing said mixture on said bonding/sealing agent comprises placing a first portion of said mixture on a first portion of said bonding/sealing agent:
said step of tamping and vibrating said mixture comprises tamping and vibrating said first portion of said mixture; and
wherein prior to said step of allowing said mixture and said bonding/sealing agent to cure, said method further comprises the steps of:
placing a second portion of said mixture on a second portion of said bonding/sealing agent as an outer layer prior to complete curing of said bonding/sealing agent;
tamping and vibrating said second portion mixture on said second portion of said bonding/sealing agent to achieve a desired thickness and density, said density being chosen such that said mixture when cured comprises irregular channels and voids.

6. A method of coating a multi-sided structural member comprising the steps of:
preparing a curable mixture of polymer granules and a bonding agent suitable for bonding said polymer granules;
applying a curable bonding/sealing agent to more than one side of said structural member as an inner layer, said bonding/sealing agent suitable for bonding said polymer granules to said structural member, said bonding/structural layer forming a liquid impermeable layer on said structural member upon curing;
placing said structural member on a vibration bed within form members, there being one or more gaps defined between said structural member and said form members;
placing an uncured first portion of said mixture in said one or more gaps as an outer layer prior to complete curing of said bonding/sealing agent;
tamping and vibrating said first portion of said mixture to achieve a desired thickness and density in said one or more gaps, said density being chosen such that said mixture when cured comprises irregular channels and voids rendering said cured mixture porous;
placing an uncured second portion of said mixture on a remaining exposed side of said bonding/sealing agent as an outer layer prior to complete curing of said bonding/sealing agent;
tamping and vibrating said second portion of said mixture to achieve a desired thickness and density, said density being chosen such that said mixture when cured comprises irregular channels and voids rendering said cured mixture porous; and
allowing said mixture and said bonding/sealing agent to cure.

7. The method of claim 6, wherein said bonding/sealing agent is applied to two opposing sides and a top of said structural member.

8. The method of claim 6, further comprising the step of choosing said polymer granules from the group of polymer granules consisting of thermoplastic vulcanizate (TPV), ethylene propylene diene monomer (EPDM), polyolefin material, or mixtures thereof.

9. The method of claim 8, wherein said polymer granules are approximately 1 to 5 mm in size and irregularly shaped.

10. The method of claim 7, further comprising the steps of:
inverting said structural member on said vibration bed to expose an uncoated opposing side of said structural member;
coating said opposing side with said curable bonding/sealing agent;
placing an uncured third portion of said mixture on said bonding/sealing agent on said opposing side;
tamping and vibrating said third portion of said mixture to achieve a desired thickness and density, said density being chosen such that said mixture when cured comprises irregular channels and voids rendering said cured mixture porous;
allowing said third portion of said mixture and said bonding/sealing agent to cure.

11. A surface coated structural member formed by the process of:
preparing a curable mixture of polymer granules and a bonding agent suitable for bonding said polymer granules;
applying a curable bonding/sealing agent to a structural member as an inner layer, said bonding/sealing agent suitable for bonding said polymer granules to said structural member and suitable for forming a liquid impermeable layer on said structural member upon curing;
placing said mixture on said bonding/sealing agent as an outer layer prior to complete curing of said bonding/sealing agent;
tamping and vibrating said mixture to achieve a desired thickness and density, said density being chosen such that said mixture when cured comprises irregular channels and voids rendering said cured mixture porous;
allowing said mixture and said bonding/sealing agent to cure;
such that said surface coated structural member comprises a liquid-impermeable inner layer and a porous outer layer.

12. The structural member of claim 11, wherein:
said step of placing said mixture on said bonding/sealing agent comprises placing a first portion of said mixture on a first portion of said bonding/sealing agent:
said step of tamping and vibrating said mixture comprises tamping and vibrating said first portion of said mixture; and
wherein prior to said step of allowing said mixture and said bonding/sealing agent to cure, said method further comprises the steps of:
placing a second portion of said mixture on a second portion of said bonding/sealing agent as an outer layer prior to complete curing of said bonding/sealing agent;
tamping and vibrating said second portion mixture on said second portion of said bonding/sealing agent to achieve a desired thickness and density, said density being chosen such that said mixture when cured comprises irregular channels and voids.

13. The structural member of claim 12, further comprising the steps of:
inverting said structural member to expose an uncoated opposing side of said structural member;
coating said opposing side with said curable bonding/sealing agent;
placing an uncured third portion of said mixture on said bonding/sealing agent on said opposing side;
tamping and vibrating said third portion of said mixture to achieve a desired thickness and density, said density being chosen such that said mixture when cured comprises irregular channels and voids rendering said cured mixture porous;
allowing said third portion of said mixture and said bonding/sealing agent to cure.
